(19) United States
(12) Patent Application Publication
(10) Pub. No.: US 2012/0290240 A1
(43) Pub. Date: Nov. 15, 2012

(54) CURRENT SENSOR FOR ELECTRIC WIRE

(75) Inventor: Hirofumi FUKUI, Miyagi-ken (JP)

(73) Assignee: ALPS GREEN DEVICES CO., LTD., Tokyo (JP)

(21) Appl. No.: 13/452,773

(22) Filed: Apr. 20, 2012

(30) Foreign Application Priority Data
May 9, 2011 (JP) 2011-103940
Apr. 5, 2012 (JP) 2012-086431

(51) Int. Cl. G06F 19/00

(52) U.S. Cl. 702/65

(57) ABSTRACT

A current sensor includes an electric wire to be measured, a guide portion for guiding the electric wire to be measured, a holding portion for holding the electric wire to be measured, and four pairs of magnetic sensor elements arranged at intervals of 90 degrees along a circumference around a center axis which is a virtual arrangement axis of the electric wire to be measured. The outputs of the magnetic sensor elements of each pair are appropriately linearly combined and the linearly combined outputs of all the pairs are added. Hence, a space for guiding the electric wire to be measured can be easily allocated, and the effects of variation sources such as the displacement of the electric wire to be measured, a constant external magnetic field, and an external magnetic field generated by a neighboring electric wire are compensated for, whereby a small high-accuracy current sensor is provided.

### CLAIM OF PRIORITY

This application claims benefit of Japanese Patent Application No. 2011-103940 filed on May 9, 2011, which is hereby incorporated by reference.

### BACKGROUND OF THE INVENTION

1. Field of the Invention

The present invention relates to current sensors for detecting, for example, the value of a current flowing through an electric wire.

2. Description of the Related Art

Related art current sensors that have been used for detecting the value of a current flowing through an electric wire include a current sensor that detects the strength of a magnetic field by arranging a magnetic sensor element at a position spaced apart from the electric wire by an appropriate distance, thereby detecting the value of a current flowing through an electric wire at that position.

However, such a method based on detection of the strength of a magnetic field has a problem in that variation in the distance between the electric wire and the current sensor due to the positional displacement of the electric wire causes generation of a measurement error.

Hence, a current sensor is known in which, to reduce a measurement error due to the positional displacement of an electric wire, a pair of magnetic sensors are arranged at positions the same distance from an electric wire with the electric wire therebetween so as to be opposite each other, as disclosed in Japanese Unexamined Patent Application Publication No. 2001-153895. When a pair of magnetic sensors are arranged so as to be opposite each other with an electric wire therebeteween in this manner, a measurement error is reduced by using the difference between or addition of the values obtained by the two magnetic sensors, even in the case where there is an influence from a constant external magnetic field or the case where the position of the electric wire under measurement is displaced a little and, hence, the distances between the electric wire and the magnetic sensors are changed.

However, with the configuration described above, although the effect of the positional displacement of an electric wire is reduced, when there exists a nearby electric wire different from the electric wire under measurement, precise measurement is not achieved due to the influence of a magnetic field generated by a current flowing through the other nearby electric wire.

### SUMMARY OF THE INVENTION

In view of the above situation, the present invention provides a current sensor that reduces the influence of an external magnetic field while reducing the effect of the positional displacement of an electric wire.

A current sensor of the present invention for measuring a measurement current flowing through an electric wire includes a plurality of magnetic sensor elements arranged around the electric wire. The plurality of the magnetic sensor elements form magnetic sensor pairs arranged on a plane perpendicular to an axis direction of the electric wire. Each of the magnetic sensor pairs is constituted by the two magnetic sensor elements having different distances from the electric wire, and the respective magnetic sensor pairs are arranged on a plurality of straight lines on the plane radiating from an intersecting point of the electric wire and the plane. The measurement current is computed by linearly combining the output values of the two magnetic sensor elements of each of the magnetic sensor pairs using a predetermined combination coefficient and by adding a plurality of the linearly combined output values.

With this configuration in the present invention, since the opposing magnetic sensor elements form magnetic sensor pairs and the output values of the two magnetic sensor elements of each of the magnetic sensor pairs are linearly combined using a predetermined combination coefficient, the influences of external magnetic fields are reduced. Further, since the measurement current is computed by adding the linearly combined output values of a plurality of the magnetic sensor pairs, the effect of the positional displacement of the electric wire is also reduced.

In the present invention, preferably, the magnetic sensor elements nearer to the electric wire within the respective magnetic sensor pairs are arranged at the same distance from the electric wire and the magnetic sensor elements farther from the electric wire within the respective magnetic sensor pairs are arranged at the same distance from the electric wire. Preferably, the predetermined combination coefficient is given by Equation (10), and the output values of the magnetic sensor elements of each of the magnetic sensor pairs are linearly combined and the linearly combined output values of all the magnetic sensor pairs are added in accordance with Equation (2).

$$\begin{matrix}A = \frac{- ( R - {Y}_{2} ) ( R + {Y}_{2} ) {Y}_{1}}{( R - {Y}_{1} ) ( R + {Y}_{1} ) {Y}_{2}} , ( {θ}_{11} = {θ}_{12} = 0 ) & ( 10 ) \\ {\sum }_{j = 1}^{N} {S}_{j} = {b}_{0} {\sum }_{j = 1}^{N} ( \frac{1}{\vert {\vec{Y}}_{j 1} - Δ \vec{X} \vert} + \frac{A}{\vert {\vec{Y}}_{j 2} - Δ \vec{X} \vert} ) + 2 {\sum }_{j = 1}^{N} {\vec{b}}_{c} \cdot {\vec{e}}_{sj} ( 1 + A ) + {b}_{nn} {\sum }_{j = 1}^{N} ( \frac{( {\vec{e}}_{sj} \cdot {\vec{e}}_{j 1} )}{\vert \vec{R} - {\vec{Y}}_{j 1} \vert} + A \frac{( {\vec{e}}_{sj} \cdot {\vec{e}}_{j 2} )}{\vert \vec{R} - {\vec{Y}}_{j 2} \vert} ) & ( 2 )\end{matrix}$$

Here, j is a symbol for identifying each of the magnetic sensor pairs, Sⱼ is a linear combination output of a magnetic sensor pair j, A is the combination coefficient, b₀ is a normalized magnetic field generated by a current flowing through the electric wire to be measured, bₙₙ is a normalized external magnetic field generated by a neighboring electric wire, b_{c} is a constant external magnetic field, eₛⱼ is a magnetic sensitivity unit vector of the magnetic sensor pair j, eⱼ₁ is a unit vector of the magnetic field of the neighboring electric wire at a position of the magnetic sensor element (hereinafter called an inner magnetic sensor element) of the magnetic sensor pair j nearer to the electric wire and eⱼ₂ is a unit vector of the magnetic field of the neighboring electric wire at a position of the magnetic sensor element (hereinafter called an outer magnetic sensor element) of the magnetic sensor pair j farther from the electric wire. Position vectors of the inner magnetic sensor element and the outer magnetic sensor element of the magnetic sensor pair j in a cross-sectional plane perpendicular to the axis direction of the electric wire to be measured are respectively Yⱼ₁ (absolute value is Y₁) and Yⱼ₂ (absolute value is Y₂), a position vector of the neighboring electric wire is R (absolute value is R), and a positional displacement vector of the electric wire to be measured is ΔX (absolute value is ΔX).

With this configuration in the present invention, even when the influences of an external magnetic field on the magnetic sensor elements are nearly the same, the influence of the external magnetic field is reduced, and the effect of the positional displacement of the electric wire is also reduced. Hence, the measurement accuracy is increased.

In the present invention, in each of the magnetic sensor pairs, when the effects of an external magnetic field on the magnetic sensor elements are different from each other because of an influence from a neighboring electric line or the like, preferably, the predetermined combination coefficient is given by Equation (9), the output values of the magnetic sensors of each of the magnetic sensor pairs are linearly combined, and the linearly combined output values of all the magnetic sensor pairs are added in accordance with Equation (2).

$$\begin{matrix}A = \frac{- {\sum }_{j = 1}^{N} \frac{( {\vec{e}}_{sj} \cdot {\vec{e}}_{j 1} )}{\vert \vec{R} - {\vec{Y}}_{j 1} \vert}}{{\sum }_{j = 1}^{N} \frac{( {\vec{e}}_{sj} \cdot {\vec{e}}_{j 2} )}{\vert \vec{R} - {\vec{Y}}_{j 2} \vert}} & ( 9 ) \\ {\sum }_{j = 1}^{N} {S}_{j} = {b}_{0} {\sum }_{j = 1}^{N} ( \frac{1}{\vert {\vec{Y}}_{j 1} - Δ \vec{X} \vert} + \frac{A}{\vert {\vec{Y}}_{j 2} - Δ \vec{X} \vert} ) + 2 {\sum }_{j = 1}^{N} {\vec{b}}_{c} \cdot {\vec{e}}_{sj} ( 1 + A ) + {b}_{nn} {\sum }_{j = 1}^{N} ( \frac{( {\vec{e}}_{sj} \cdot {\vec{e}}_{j 1} )}{\vert \vec{R} - {\vec{Y}}_{j 1} \vert} + A \frac{( {\vec{e}}_{sj} \cdot {\vec{e}}_{j 2} )}{\vert \vec{R} - {\vec{Y}}_{j 2} \vert} ) & ( 2 )\end{matrix}$$

Here, j is a symbol for identifying each of the magnetic sensor pairs, Sⱼ is a linear combination output of a magnetic sensor pair j, A is the combination coefficient, b₀ is a normalized magnetic field generated by a current flowing through the electric wire to be measured, bₙₙ is a normalized external magnetic field generated by a neighboring electric wire, b_{c} is a constant external magnetic field, eₛⱼ is a magnetic sensitivity unit vector of the magnetic sensor pair j, eⱼ₁ is a unit vector of the magnetic field of the neighboring electric wire at a position of the magnetic sensor element (hereinafter called an inner magnetic sensor element) of the magnetic sensor pair j nearer to the electric wire and eⱼ₂ is a unit vector of the magnetic field of the neighboring electric wire at a position of the magnetic sensor element (hereinafter called an outer magnetic sensor element) of the magnetic sensor pair j farther from the electric wire. Position vectors of the inner magnetic sensor element and the outer magnetic sensor element of the magnetic sensor pair j in a cross-sectional plane perpendicular to the axis direction of the electric wire to be measured are respectively Yⱼ₁ (absolute value is Y₁) and Yⱼ₂ (absolute value is Y₂), a position vector of the neighboring electric wire is R (absolute value is R), and a positional displacement vector of the electric wire to be measured is ΔX (absolute value is ΔX).

With this configuration in the present invention, even when the influences of an external magnetic field on the magnetic sensor elements are different from each other, the influences of the external magnetic field are reduced, and the effect of the positional displacement of the electric wire is also reduced. Hence, the measurement accuracy is increased.

In the present invention, preferably, a support body for holding the plurality of the magnetic sensor elements is provided and the support body includes a holding portion for holding the electric wire and a guide portion for guiding the electric wire to the holding portion.

With this configuration in the present invention, since the sensor apparatus need not be divided to guide an electric wire as in a clamp-type current sensor, a current sensor having long-term reliability is provided.

In the present invention, preferably, inner and outer magnetic sensor elements constituting a plurality of the magnetic sensor pairs are respectively arranged along two circumferences having different radiuses from the center of the electric wire.

With this configuration in the present invention, the effects of the positional displacement of an electric wire and an external magnetic field are reduced, whereby a high-accuracy current sensor is provided.

In the present invention, preferably, the magnetic sensor pairs are arranged at equal intervals.

With this configuration in the present invention, the effects of the positional displacement of an electric wire and an external magnetic field are reduced, whereby a high-accuracy current sensor is provided.

In the present invention, preferably, four of the magnetic sensor pairs are arranged at equal intervals of 90 degrees.

With this configuration in the present invention, the effects of the positional displacement of an electric wire and an external magnetic field are reduced, whereby a high-accuracy current sensor is provided.

### BRIEF DESCRIPTION OF THE DRAWINGS

FIG. 1 is an arrangement diagram illustrating an electric wire to be measured and magnetic sensor elements according to an embodiment (first embodiment) of the present invention.

FIG. 2 is an arrangement diagram illustrating an electric wire to be measured, magnetic sensor elements, and a neighboring electric wire for explaining a method of determining a linear combination coefficient according to the embodiment (first embodiment).

FIG. 3 is a diagram illustrating comparison results regarding the dependency of a current measurement error on the position (angle) of a neighboring electric wire for differential and non-differential methods for the case of four element pairs in the embodiment (first embodiment).

FIG. 4 is a diagram illustrating results regarding the dependency of a current measurement error on the position (angle) of a neighboring electric wire for the cases where the numbers of element pairs are 2 to 5 in the embodiment (first embodiment).

FIG. 5 is a diagram illustrating results regarding the dependency of a current measurement error on the positional displacement of an electric wire to be measured under the influence of a current of a neighboring electric wire for the case of four element pairs in the embodiment (first embodiment).

### DESCRIPTION OF THE PREFERRED EMBODIMENTS

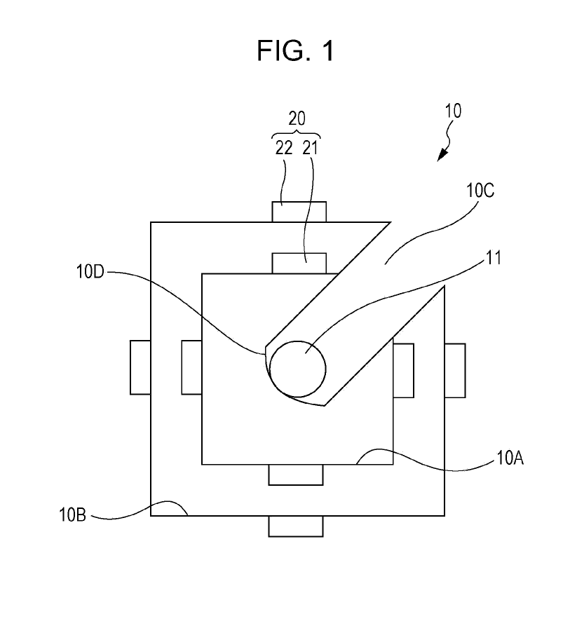

Hereinafter, a current sensor according to an embodiment of the present invention is described with reference to FIGS. 1 to 5.

Referring to FIG. 1, a current sensor of the present invention preferably includes a square support body 10, and the support body 10 has inner surfaces 10A and outer surfaces 10B formed correspondingly to the four sides thereof. One corner of the support body 10 is preferably cut off so as to form an electric wire guide 10C, which can guide an electric wire 11 to be measured to the center of the support body 10. The electric wire guide 10C extends to the center of the support body 10, and the end of the extended portion may form an electric wire holding portion 10D, where the guided electric wire 11 to be measured is held at the center of the support body 10.

Inner magnetic sensor elements 21 and outer magnetic sensor elements 22 are arranged, so as to be opposite each other, respectively on the inner surface 10A and the outer surface 10B along directions perpendicular to the direction of the axis of the electric wire 11 to be measured guided to the center of the support body 10. The inner magnetic sensor elements 21 and outer magnetic sensor elements 22 arranged so as to be opposite each other in this manner preferably form four magnetic sensor pairs 20 arranged at equal intervals of 90 degrees around the electric wire 11 as the center.

The inner magnetic sensor elements 21 and the outer magnetic sensor elements 22, which are formed of magnetoresistive sensors, such as giant magnetic resistive (GMR) sensors, detect the strength of a magnetic field generated by a current flowing thorough the electric wire 11 to be measured. Signals that are output from the inner magnetic sensor elements 21 and the outer magnetic sensor elements 22 are input to a signal processing unit via amplifier circuits (not illustrated). The signal processing unit, which includes an arithmetic processing circuit and a memory, computes the value of a current flowing through the electric wire 11, by linearly combining an output value based on the signal output from the inner magnetic sensor element 21 and an output value based on the signal output from the outer magnetic sensor element 22 for each of the magnetic sensor pairs 20 using a predetermined linear combination coefficient, and by adding together the linearly combined output values of the respective magnetic sensor pairs 20.

Linear combination performed for the magnetic sensor pairs 20 and a method for computing the value of a current on the basis of the linearly combined output values will now be described in detail.

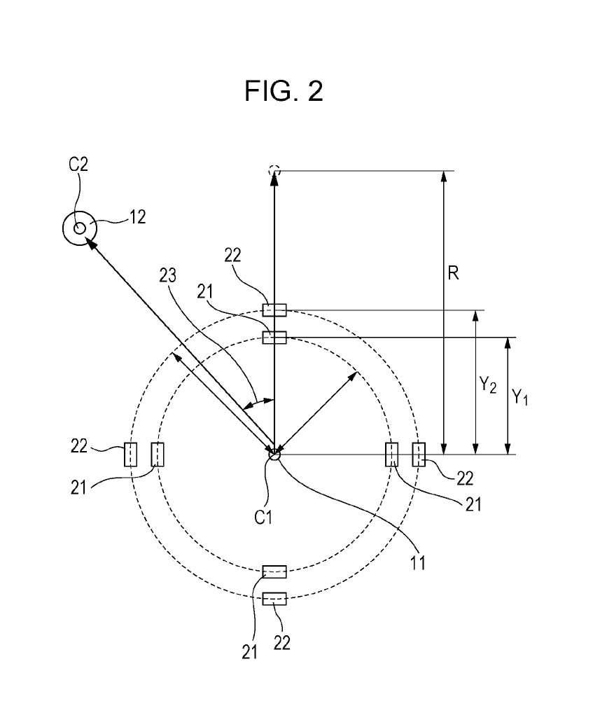

External magnetic fields that affect the measurement of a current using a current sensor, considered here, are a normalized external magnetic field bnn due to another electric wire (hereinafter called a neighboring electric wire 12) neighboring the electric wire 11 to be measured and a constant external magnetic field bc due to other external devices and the like (not illustrated). Referring to FIG. 2, it is supposed that the distance between the center C1 of the electric wire 11 to be measured and the inner magnetic sensor element 21 is Y1, and the distance between the center C1 of the electric wire 11 to be measured and the outer magnetic sensor element 22 is Y2. It is also supposed that all the sensitivity axes of the inner magnetic sensor elements 21 and the outer magnetic sensor elements 22 coincide with the tangent lines of circles, whose centers are the electric wire 11 to be measured, at positions where the inner magnetic sensor elements 21 and the outer magnetic sensor elements 22 are placed and that the directions of the sensitivity axes are set in such a manner as to be in the counterclockwise directions when viewed in the direction (direction perpendicular to the plane of FIG. 1) of the current flow.

Assuming that each of the magnetic sensor pairs is identified by j (FIG. 1 illustrates the case of four magnetic sensor pairs where j=1 to 4), a sensor output Sⱼ of a magnetic sensor pair j may be expressed by Equation (1), where the combination coefficient for the output values of the inner and outer magnetic sensor elements is A.

$$\begin{matrix}{S}_{j} = \frac{{b}_{0}}{\vert {\vec{Y}}_{j 1} - Δ \vec{X} \vert} + \frac{{b}_{nn} ( {\vec{e}}_{sj} \cdot {\vec{e}}_{j 1} )}{\vert \vec{R} - {\vec{Y}}_{j 1} \vert} + \\ {\vec{b}}_{c} \cdot {\vec{e}}_{sj} + A ( \frac{{b}_{0}}{\vert {\vec{Y}}_{j 2} - Δ \vec{X} \vert} + \frac{{b}_{nn} ( {\vec{e}}_{sj} \cdot {\vec{e}}_{j 2} )}{\vert \vec{R} - {\vec{Y}}_{j 2} \vert} + {b}_{c} ) \\ = {b}_{0} ( \frac{1}{\vert {\vec{Y}}_{j 1} - Δ \vec{X} \vert} + \frac{A}{\vert {\vec{Y}}_{j 2} - Δ \vec{ X} \vert} ) + \\ {\vec{b}}_{c} \cdot {\vec{e}}_{sj} ( 1 + A ) + {b}_{nn} ( \frac{( {\vec{e}}_{sj} \cdot {\vec{e}}_{j 1} )}{\vert \vec{R} - {\vec{Y}}_{j 1} \vert} + A \frac{( {\vec{e}}_{sj} \cdot {\vec{e}}_{j 2} )}{\vert \vec{R} - {\vec{Y}}_{j 2} \vert} )\end{matrix} \qquad ( 1 )$$

Here, it is supposed that a normalized magnetic field generated by a current flowing through the electric wire 11 to be measured is b₀, a normalized external magnetic field generated by the neighboring electric wire 12 is bₙₙ, a constant external magnetic field, which is independent of positions, is b_{c}, the magnetic sensitivity unit vector of the magnetic sensor pair j is eₛⱼ, and the unit vectors of neighboring electric wire magnetic fields at the positions of the inner and outer magnetic sensor elements of the magnetic sensor pair j are eⱼ₁ and eⱼ₂. It is also supposed that the position vectors of the inner and outer magnetic sensor elements of the magnetic sensor pair j in a cross-sectional plane perpendicular to the axis direction of the electric wire to be measured are Yⱼ₁ (absolute value is Y₁) and Yⱼ₂ (absolute value is Y₂), the position vector of a neighboring electric wire is R (absolute value is R), and the positional displacement vector of the electric wire to be measured is ΔX (absolute value is ΔX).

The sum of the outputs of the magnetic sensor pairs is expressed by Equation (2) (N is the number of the magnetic sensor pairs, and preferably N=4 in the present example).

$${\sum }_{j = 1}^{N} {S}_{j} = {b}_{0} {\sum }_{j = 1}^{N} ( \frac{1}{\vert {\vec{Y}}_{j 1} - Δ \vec{X} \vert} + \frac{A}{\vert {\vec{Y}}_{j 2} - Δ \vec{X} \vert} ) + 2 {\sum }_{j = 1}^{N} {\vec{b}}_{c} \cdot {\vec{e}}_{sj} ( 1 + A ) + {b}_{nn} {\sum }_{j = 1}^{N} ( \frac{( {\vec{e}}_{sj} \cdot {\vec{e}}_{j 1} )}{\vert \vec{R} - {\vec{Y}}_{j 1} \vert} + A \frac{( {\vec{e}}_{sj} \cdot {\vec{e}}_{j 2} )}{\vert \vec{R} - {\vec{Y}}_{j 2} \vert} ) \qquad ( 2 )$$

The measurement error of a current to be measured is expressed by the ratio of the sum of the second and third terms to the first term of Equation (2), and is given by Equation (3).

$$error ( \% ) = 100 \times ( 2 {\sum }_{j = 1}^{N} {\vec{b}}_{c} \cdot {\vec{e}}_{sj} ( 1 + A ) + {b}_{nn} {\sum }_{j = 1}^{N} ( \frac{( {\vec{e}}_{sj} \cdot {\vec{e}}_{j 1} )}{\vert \vec{R} - {\vec{Y}}_{j 1} \vert} + A \frac{( {\vec{e}}_{sj} \cdot {\vec{e}}_{j 2} )}{\vert \vec{R} - {\vec{Y}}_{j 2} \vert} ) ) / {b}_{0} {\sum }_{j = 1}^{N} ( \frac{1}{\vert {\vec{Y}}_{j 1} - Δ \vec{X} \vert} + \frac{A}{\vert {\vec{Y}}_{j 2} - Δ \vec{X} \vert} ) \qquad ( 3 )$$

By expanding Equation (2) in terms of the positional displacement ΔX of the electric wire to be measured, Equation (4) is obtained.

$${\sum }_{j = 1}^{N} {S}_{j} = {b}_{0 } {\sum }_{j = 1}^{N} ( \frac{1}{{Y}_{1}} ( 1 + \frac{1}{2} ( \frac{Δ X}{{Y}_{1}} ) cos {θ}_{j 1} + O ( {( Δ X / {Y}_{1} )}^{2} ) ) + \frac{A}{{Y}_{2}} ( 1 + \frac{1}{2} ( \frac{Δ X}{{Y}_{2}} ) cos {θ}_{j 2} + O ( {( Δ X / {Y}_{2} )}^{2} ) ) ) + {b}_{c} N ( 1 + A ) + {b}_{nn} {\sum }_{j = 1}^{N} ( \frac{( {\vec{e}}_{sj} \cdot {\vec{e}}_{j 1} )}{\vert \vec{R} - {\vec{Y}}_{j 1} \vert} + A \frac{( {\vec{e}}_{sj} \cdot {\vec{e}}_{j 2} )}{\vert \vec{R} - {\vec{Y}}_{j 2} \vert} ) \qquad ( 4 )$$

Here, θⱼ₁ and θⱼ₂ are angles respectively formed by the inner and outer magnetic sensor element positions of magnetic sensor pair j and the center C2 of the neighboring electric wire. Since the inner magnetic sensor elements and the outer magnetic sensor elements are preferably respectively arranged at equal angular intervals along two circumferences having different radiuses from the center of the electric wire to be measured, Equations (5) and (6) are obtained. Here, a subscript k takes a value of 1 or 2, and θ₀ is a constant.

$$\begin{matrix}cos {θ}_{jk} = \frac{( {\vec{Y}}_{jk} \cdot \vec{R} )}{\vert {\vec{Y}}_{jk} \vert \vert \vec{R} \vert} = cos ( 2 π ( j - 1 ) / N + {θ}_{0} ) & ( 5 ) \\ {\sum }_{j = 1}^{N} cos {θ}_{jk} = {\sum }_{j = 1}^{N} cos ( 2 π ( j - ) / N + {θ}_{0} ) = 0 & ( 6 )\end{matrix}$$

When these results are reflected in Equation (2), Equation (7) is obtained.

$${\sum }_{j = 1}^{N} {S}_{j} = {b}_{0} {\sum }_{j = 1}^{N} ( \frac{1}{{Y}_{1}} ( 1 + O ( {( Δ X / {Y}_{1} )}^{2} ) ) + \frac{A}{{Y}_{2}} ( 1 + O ( {( Δ X / {Y}_{2} )}^{2} ) ) ) + 2 {\sum }_{j = 1}^{N} {\vec{b}}_{c} \cdot {\vec{e}}_{sj} ( 1 + A ) + {b}_{nn} {\sum }_{j = 1}^{N} ( \frac{( {\vec{e}}_{sj} \cdot {\vec{e}}_{j 1} )}{\vert \vec{R} - {\vec{Y}}_{j 1} \vert} + A \frac{( {\vec{e}}_{sj} \cdot {\vec{e}}_{j 2} )}{\vert \vec{R} - {\vec{Y}}_{j 2} \vert} ) \qquad ( 7 )$$

It can be seen from Equation (7) that the effect of the positional displacement of the electric wire to be measured is limited to a minute amount corresponding to the positional displacement ΔX to the second or higher power. In other words, the effect of the positional displacement of the electric wire to be measured is sufficiently cancelled out.

Here, the influence of a constant external magnetic field is discussed. As described above, since all the sensitivity axes of the inner magnetic sensor elements 21 and the outer magnetic sensor elements 22 coincide with the tangent lines of circles, whose centers are the electric wire 11 to be measured, at positions where the inner magnetic sensor elements 21 and the outer magnetic sensor elements 22 are placed and the directions of the sensitivity axes are set in such a manner as to be in the counterclockwise directions when viewed in the direction (direction perpendicular to the plane of FIG. 1) of the current flow, Equation (8) is satisfied. In other words, the influence of the constant external magnetic field is cancelled out.

$${\sum }_{j = 1}^{N} {\vec{b}}_{c} \cdot {\vec{e}}_{sj} = 0 \qquad ( 8 )$$

Next, the linear combination coefficient A is determined. When the coefficient terms of bₙₙ are set to zero in Equation (2), Equation (9) is obtained. With this linear combination coefficient A, the effect of the neighboring electric wire is cancelled out. In other words, both the effects of the positional displacement of the electric wire to be measured and the external magnetic fields (both the constant external magnetic field and the external magnetic field generated by the neighboring electric wire) are cancelled out.

$$A = \frac{- {\sum }_{j = 1}^{N} \frac{( {\vec{e}}_{sj} \cdot {\vec{e}}_{j 1} )}{\vert \vec{R} - {\vec{Y}}_{j 1} \vert}}{{\sum }_{j = 1}^{N} \frac{( {\vec{e}}_{sj} \cdot {\vec{e}}_{j 2} )}{\vert \vec{R} - {\vec{Y}}_{j 2} \vert}} \qquad ( 9 )$$

In the present embodiment, preferably the number N of magnetic sensor pairs is four, and a configuration has been selected in which the neighboring electric wire, magnetic sensor pair 1, and the electric wire to be measured are arranged in a straight line. In this case, equation (10) is obtained from Equation (9).

$$A = \frac{- ( R - {Y}_{2} ) ( R + {Y}_{2} ) {Y}_{1}}{( R - {Y}_{1} ) ( R + {Y}_{1} ) {Y}_{2}} , ( {θ}_{11} = {θ}_{12} = 0 ) \qquad ( 10 )$$

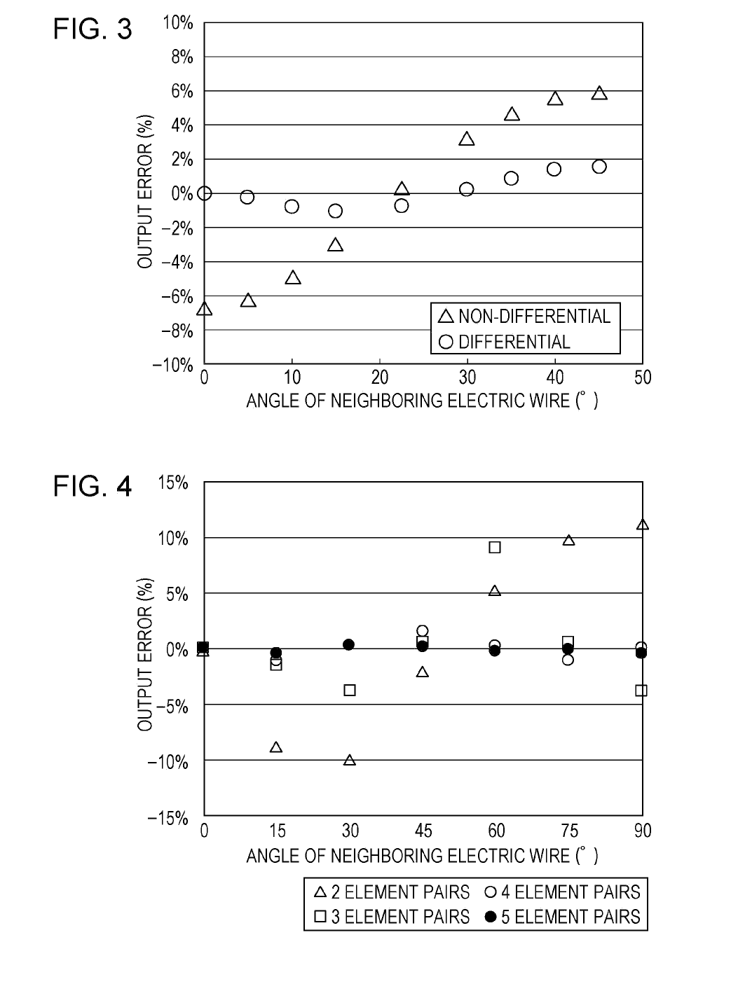

Referring to FIGS. 2 and 3, the advantageous effect of the present invention for suppressing the influence of a current that flows through a neighboring electric wire will now be specifically described. The current measurement error was computed using Equation (3) under the conditions that the number of the magnetic sensor pairs is four, and in FIG. 2, R=8 mm, Y₁=4 mm, and Y₂=5 mm, and that the position of the neighboring electric wire is rotated around the electric wire to be measured while the distance R between the electric wire to be measured and the neighboring electric wire is fixed to 8 mm. The rotation angle θ is supposed to be 0° when the neighboring electric wire is located on an extended portion of a straight line passing through the position of the electric wire to be measured and one of the magnetic sensor pairs. The linear combination coefficient of the magnetic sensor element output described above corresponds to the case of 0°, and has been optimized using the method described above, resulting in A=−39/60 from Equation (10). The case of evaluation in which this optimization processing has been performed is called differential and the case in which A=0 without performing the optimization processing is called non-differential. FIG. 3 illustrates the results of the current measurement error for the differential and non-differential cases obtained when the position of neighboring electric wire is changed from 0° to 45° in terms of θ. It can be seen that although the maximum current measurement error exceeds 5% in the non-differential case, the maximum current measurement error is suppressed to 2% or less in the differential case.

Referring to FIG. 4, description will now be made regarding how the measurement error due to the effect of the neighboring electric wire changes with the number of pairs of magnetic sensor elements. The current measurement error was computed using Equation (3) under the conditions that R=8 mm, Y1=4 mm, and Y2=5 mm while changing the position of the neighboring electric wire from 0° to 90° in terms of θ for the numbers of magnetic sensor pairs of 2, 3, 4, and 5. The linear combination coefficient for the output of the magnetic sensor pairs has been optimized for each of the numbers of the magnetic sensor pairs using Equation (9). It can be seen that the maximum measurement error is limited to 2% or less when the number of the magnetic sensor pairs is 4 or more.

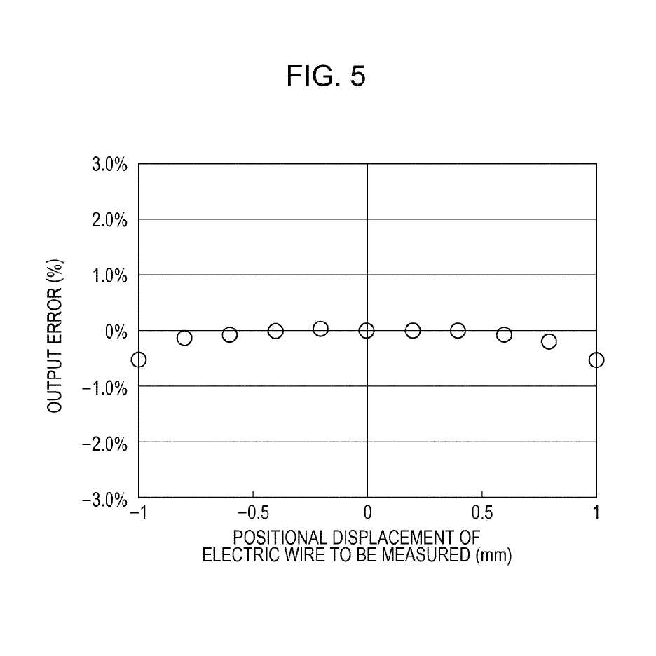

Next, referring to FIG. 5, the current measurement error due to the positional displacement of the electric wire to be measured under the influence of a current flowing through a neighboring electric wire will be described for the case of four magnetic sensor pairs. The neighboring electric wire is in the direction of θ=0°, R=8 mm, Y1=4 mm, and Y2=5 mm. The current measurement error was computed using Equation (3) for the case where the electric wire to be measured is displaced by −1 mm to +1 mm along a straight line with θ=0°. Also in this case, the linear combination coefficient has been optimized by making A=−39/60. It can be seen that the current measurement error is limited to 1% or less for the positional displacement of the electric wire to be measured ranging from −1 mm to +1 mm.

The present embodiment based on the configuration described above has the following advantageous effects.

According to the present embodiment, the inner magnetic sensor elements 21 and the outer magnetic sensor elements 22 are arranged so as to be opposite each other to form the magnetic sensor pairs 20, the magnetic sensor pairs 20 are preferably arranged at equal angular intervals along a circumference, and the output values of the inner magnetic sensor element 21 and the outer magnetic sensor element 22 forming each pair are linearly combined using a predetermined linear combination coefficient A, whereby the influences of the position dependent normalized external magnetic field bnn and the constant external magnetic field bc are removed. Further, the linearly combined output values Sj of the magnetic sensor pairs 20 are added together, and the obtained sum ΣSj is used to compute a measurement current. Hence, the effect of the positional displacement of an electric wire to be measured is also reduced. In other words, the measurement error of a current to be measured is reduced even when there are both the positional displacement of a current path and variations in external magnetic field.

In addition, by using a magnetic sensor pair configuration, a sufficient space can be easily allocated to an electric wire guide, and the freedom in selecting the number of magnetic sensors in accordance with an objective is increased.

Further, since there is no need to divide a sensor apparatus to guide an electric wire as in a clamp-type current sensor, a current sensor having long-term reliability is provided.

Note that the present invention is not limited to the embodiment described above, and can be realized in various modifications described below. These embodiments are also within the technical scope of the present invention.

(1) In the embodiment described above, a configuration is used in which the four magnetic sensor pairs 20 formed of the inner magnetic sensor elements 21 and the outer magnetic sensor elements 22 are arranged at equal intervals of 90 degrees around the electric wire 11 to be measured. However, there is no need for arrangement at equal intervals of 90 degrees and it is sufficient to employ an arrangement that satisfies Equation (6). Further, any arrangement that satisfies Equation (6) can be employed, for example, two pairs or three pairs other than four pairs.

(2) In the embodiment described above, description has been made regarding a method of removing the effects of the positional displacement of an electric line to be measured and the normalized external magnetic field bnn generated by a neighboring electric line, while setting the linear combination coefficient A to −39/60. However, a configuration may be used in which by optimizing the linear combination coefficient in accordance with the generation source of an external magnetic field or the position thereof, for example, the output value of the inner magnetic sensor elements and the output value of the outer magnetic sensor elements are linearly combined, whereby the influences of external magnetic fields are removed.

(3) In the embodiment described above, the inner magnetic sensor elements 21 or the outer magnetic sensor elements 22 are GMR elements. However, any element, such as an MR element or a Hall element, that can detect a magnetic field may be used.

The present invention can be realized in various modifications within the scope of the present invention, in addition to the modifications described above.

1. A current sensor for measuring a measurement current flowing through an electric wire, the sensor comprising:
a plurality of magnetic sensor pairs arranged around the electric wire, the plurality of the magnetic sensor pairs being arranged on a virtual plane perpendicular to an axis direction of the electric wire, such that each of the plurality of magnetic sensor pairs is arranged along corresponding one of a plurality of straight lines on the virtual plane which radiate from an intersecting point of the electric wire and the virtual plane,
wherein each of the magnetic sensor pairs includes inner and outer magnetic sensor elements having different distances from the electric wire along the straight line, and
wherein the measurement current is computed by linearly combining the output values of the inner and outer magnetic sensor elements of each of the magnetic sensor pairs using a predetermined combination coefficient and by adding a plurality of the linearly combined output values.

2. The current sensor according to claim 1,
wherein the inner magnetic sensor elements is closer to the electric wire than the outer magnetic sensor element, the inner and outer magnetic sensor elements of each magnetic sensor pair being positioned at predetermined first and second distances from the electric wire, respectively,
wherein the predetermined combination coefficient is given by Equation (10), the output values of the inner and outer magnetic sensor elements of each of the magnetic sensor pairs are linearly combined, and the linearly combined output values of all the magnetic sensor pairs are added in accordance with Equation (2), Equations (10) and (2) being
$$\begin{matrix}A = \frac{- ( R - {Y}_{2} ) ( R + {Y}_{2} ) {Y}_{1}}{( R - {Y}_{1} ) ( R + {Y}_{1} ) {Y}_{2}} , ( {θ}_{11} = {θ}_{12} = 0 ) and & ( 10 ) \\ {\sum }_{j = 1}^{N} {S}_{j} = {b}_{0} {\sum }_{j = 1}^{N} ( \frac{1}{\vert {\vec{Y}}_{j 1} - Δ \vec{X} \vert} + \frac{A}{\vert {\vec{Y}}_{j 2} - Δ \vec{X} \vert} ) + 2 {\sum }_{j = 1}^{N} {\vec{b}}_{c} \cdot {\vec{e}}_{sj} ( 1 + A ) + {b}_{nn} {\sum }_{j = 1}^{N} ( \frac{( {\vec{e}}_{sj} \cdot {\vec{e}}_{j 1} )}{\vert \vec{R} - {\vec{Y}}_{j 1} \vert} + A \frac{( {\vec{e}}_{sj} \cdot {\vec{e}}_{j 2} )}{\vert \vec{R} - {\vec{Y}}_{j 2} \vert} ) , & ( 2 )\end{matrix}$$
wherein j denotes a symbol for identifying each of the magnetic sensor pairs, Sⱼ denotes a linear combination output of a magnetic sensor pair j, A denotes the combination coefficient, b₀ denotes a normalized magnetic field generated by a current flowing through the electric wire to be measured, bₙₙ denotes a normalized external magnetic field generated by a neighboring electric wire, b_{c} denotes a constant external magnetic field, eₛⱼ denotes a magnetic sensitivity unit vector of the magnetic sensor pair j, eⱼ₁ denotes a unit vector of the magnetic field of the neighboring electric wire at a position of the inner magnetic sensor element of the magnetic sensor pair j, and eⱼ₂ denotes a unit vector of the magnetic field of the neighboring electric wire at a position of the outer magnetic sensor element of magnetic sensor pair j, and
wherein position vectors of the inner magnetic sensor element and the outer magnetic sensor element of the magnetic sensor pair j in a cross-sectional plane perpendicular to the axis direction of the electric wire to be measured are referred to as Yⱼ₁ (absolute value is Y₁) and Yⱼ₂ (absolute value is Y₂), respectively, a position vector of the neighboring electric wire is referred to as R (absolute value is R), and a positional displacement vector of the electric wire to be measured is referred to as ΔX (absolute value is ΔX).

3. The current sensor according to claim 1,
wherein, in each of the magnetic sensor pairs, when the effects of an external magnetic field on the inner and outer magnetic sensor elements are different from each other, the predetermined combination coefficient is given by Equation (9), the output values of the inner and outer magnetic sensor elements of each of the magnetic sensor pairs are linearly combined, and the linearly combined output values of all the magnetic sensor pairs are added in accordance with Equation (2), Equations (9) and (2) being
$$\begin{matrix}A = \frac{- {\sum }_{j = 1}^{N} \frac{( {\vec{e}}_{sj} \cdot {\vec{e}}_{j 1} )}{\vert \vec{R} - {\vec{Y}}_{j 1} \vert}}{{\sum }_{j = 1}^{N} \frac{( {\vec{e}}_{sj} \cdot {\vec{e}}_{j 2} )}{\vert \vec{R} - {\vec{Y}}_{j 2} \vert}} and & ( 9 ) \\ {\sum }_{j = 1}^{N} {S}_{j} = {b}_{0} {\sum }_{j = 1}^{N} ( \frac{1}{\vert {\vec{Y}}_{j 1} - Δ \vec{X} \vert} + \frac{A}{\vert {\vec{Y}}_{j 2} - Δ \vec{X} \vert} ) + 2 {\sum }_{j = 1}^{N} {\vec{b}}_{c} \cdot {\vec{e}}_{sj} ( 1 + A ) + {b}_{nn} {\sum }_{j = 1}^{N} ( \frac{( {\vec{e}}_{sj} \cdot {\vec{e}}_{j 1} )}{\vert \vec{R} - {\vec{Y}}_{j 1} \vert} + A \frac{( {\vec{e}}_{sj} \cdot {\vec{e}}_{j 2} )}{\vert \vec{R} - {\vec{Y}}_{j 2} \vert} ) , & ( 2 )\end{matrix}$$
wherein j denotes a symbol for identifying each of the magnetic sensor pairs, Sⱼ denotes a linear combination output of a magnetic sensor pair j, A denotes the combination coefficient, b₀ denotes a normalized magnetic field generated by a current flowing through the electric wire to be measured, bₙₙ denotes a normalized external magnetic field generated by a neighboring electric wire, b_{c} denotes a constant external magnetic field, eₛⱼ denotes a magnetic sensitivity unit vector of the magnetic sensor pair j, eⱼ₁ denotes a unit vector of the magnetic field of the neighboring electric wire at a position of the inner magnetic sensor element of the magnetic sensor pair j, and eⱼ₂ denotes a unit vector of the magnetic field of the neighboring electric wire at a position of the outer magnetic sensor element of magnetic sensor pair j, and
wherein position vectors of the inner magnetic sensor element and the outer magnetic sensor element of the magnetic sensor pair j in a cross-sectional plane perpendicular to the axis direction of the electric wire to be measured are referred to as Yⱼ₁ (absolute value is Y₁) and Yⱼ₂ (absolute value is Y₂), respectively, a position vector of the neighboring electric wire is referred to as R (absolute value is R), and a positional displacement vector of the electric wire to be measured is referred to as ΔX (absolute value is ΔX).

4. The current sensor according to claim 1, further comprising:
a support body for holding the plurality of the magnetic sensor pairs,
wherein the support body includes a holding portion for holding the electric wire and a guide portion for guiding the electric wire to the holding portion.

5. The current sensor according to claim 1, wherein the inner and outer magnetic sensor elements forming the plurality of the magnetic sensor pairs are respectively arranged along two circumferences having different radiuses from the center of the electric wire.

6. The current sensor according to claim 5, wherein the plurality of magnetic sensor pairs are arranged at equal intervals.

7. The current sensor according to claim 6, wherein the plurality of magnetic sensor pairs includes four pairs arranged at equal intervals of 90 degrees around the center of the electric wire.

8. A current sensor for measuring a measurement current flowing through an electric wire, the sensor comprising:
a plurality of magnetic sensor pairs arranged around the electric wire, the plurality of the magnetic sensor pairs being arranged on a virtual plane perpendicular to an axis direction of the electric wire, such that each of the plurality of magnetic sensor pairs is arranged along corresponding one of a plurality of straight lines on the virtual plane which radiate from an intersecting point of the electric wire and the virtual plane; and
a signal processing unit coupled to each of the plurality of the magnetic sensor pairs,
wherein each of the magnetic sensor pairs includes inner and outer magnetic sensor elements having different distances from the electric wire along the straight line, and
wherein the signal processing unit is configured to compute the measurement current by linearly combining the output values of the inner and outer magnetic sensor elements of each of the magnetic sensor pairs using a predetermined combination coefficient and by adding a plurality of the linearly combined output values.

9. A method for measuring a measurement current flowing through an electric wire, the method comprising:
providing a plurality of magnetic sensor pairs around the electric wire, the plurality of the magnetic sensor pairs being arranged on a virtual plane perpendicular to an axis direction of the electric wire, such that each of the plurality of magnetic sensor pairs is arranged along corresponding one of a plurality of straight lines on the virtual plane which radiate from an intersecting point of the electric wire and the virtual plane, each of the magnetic sensor pairs including inner and outer magnetic sensor elements having different distances from the electric wire along the straight line, and
computing the measurement current by linearly combining the output values of the inner and outer magnetic sensor elements of each of the magnetic sensor pairs using a predetermined combination coefficient and by adding a plurality of the linearly combined output values.

10. The method according to claim 9,
wherein the inner magnetic sensor elements is closer to the electric wire than the outer magnetic sensor element, the inner and outer magnetic sensor elements of each magnetic sensor pair being positioned at predetermined first and second distances from the electric wire, respectively,
wherein the predetermined combination coefficient is given by Equation (10), the output values of the inner and outer magnetic sensor elements of each of the magnetic sensor pairs are linearly combined, and the linearly combined output values of all the magnetic sensor pairs are added in accordance with Equation (2), Equations (10) and (2) being
$$\begin{matrix}A = \frac{- ( R - {Y}_{2} ) ( R + {Y}_{2} ) {Y}_{1}}{( R - {Y}_{1} ) ( R + {Y}_{1} ) {Y}_{2}} , ( {θ}_{11} = {θ}_{12} = 0 ) and & ( 10 ) \\ {\sum }_{j = 1}^{N} {S}_{j} = {b}_{0} {\sum }_{j = 1}^{N} ( \frac{1}{\vert {\vec{Y}}_{j 1} - Δ \vec{X} \vert} + \frac{A}{\vert {\vec{Y}}_{j 2} - Δ \vec{X} \vert} ) + 2 {\sum }_{j = 1}^{N} {\vec{b}}_{c} \cdot {\vec{e}}_{sj} ( 1 + A ) + {b}_{nn} {\sum }_{j = 1}^{N} ( \frac{( {\vec{e}}_{sj} \cdot {\vec{e}}_{j 1} )}{\vert \vec{R} - {\vec{Y}}_{j 1} \vert} + A \frac{( {\vec{e}}_{sj} \cdot {\vec{e}}_{j 2} )}{\vert \vec{R} - {\vec{Y}}_{j 2} \vert} ) , & ( 2 )\end{matrix}$$
wherein j denotes a symbol for identifying each of the magnetic sensor pairs, Sⱼ denotes a linear combination output of a magnetic sensor pair j, A denotes the combination coefficient, b₀ denotes a normalized magnetic field generated by a current flowing through the electric wire to be measured, bₙₙ denotes a normalized external magnetic field generated by a neighboring electric wire, b_{c} denotes a constant external magnetic field, eₛⱼ denotes a magnetic sensitivity unit vector of the magnetic sensor pair j, eⱼ₁ denotes a unit vector of the magnetic field of the neighboring electric wire at a position of the inner magnetic sensor element of the magnetic sensor pair j, and eⱼ₂ denotes a unit vector of the magnetic field of the neighboring electric wire at a position of the outer magnetic sensor element of magnetic sensor pair j, and
wherein position vectors of the inner magnetic sensor element and the outer magnetic sensor element of the magnetic sensor pair j in a cross-sectional plane perpendicular to the axis direction of the electric wire to be measured are referred to as Yⱼ₁ (absolute value is Y₁) and Yⱼ₂ (absolute value is Y₂), respectively, a position vector of the neighboring electric wire is referred to as R (absolute value is R), and a positional displacement vector of the electric wire to be measured is referred to as ΔX (absolute value is ΔX).

11. The method according to claim 9,
wherein, in each of the magnetic sensor pairs, when the effects of an external magnetic field on the inner and outer magnetic sensor elements are different from each other, the predetermined combination coefficient is given by Equation (9), the output values of the inner and outer magnetic sensor elements of each of the magnetic sensor pairs are linearly combined, and the linearly combined output values of all the magnetic sensor pairs are added in accordance with Equation (2), Equations (9) and (2) being
$$\begin{matrix}A = \frac{- {\sum }_{j = 1}^{N} \frac{( {\vec{e}}_{sj} \cdot {\vec{e}}_{j 1} )}{\vert \vec{R} - {\vec{Y}}_{j 1} \vert}}{{\sum }_{j = 1}^{N} \frac{( {\vec{e}}_{sj} \cdot {\vec{e}}_{j 2} )}{\vert \vec{R} - {\vec{Y}}_{j 2} \vert}} and & ( 9 ) \\ {\sum }_{j = 1}^{N} {S}_{j} = {b}_{0} {\sum }_{j = 1}^{N} ( \frac{1}{\vert {\vec{Y}}_{j 1} - Δ \vec{X} \vert} + \frac{A}{\vert {\vec{Y}}_{j 2} - Δ \vec{X} \vert} ) + 2 {\sum }_{j = 1}^{N} {\vec{b}}_{c} \cdot {\vec{e}}_{sj} ( 1 + A ) + {b}_{nn} {\sum }_{j = 1}^{N} ( \frac{( {\vec{e}}_{sj} \cdot {\vec{e}}_{j 1} )}{\vert \vec{R} - {\vec{Y}}_{j 1} \vert} + A \frac{( {\vec{e}}_{sj} \cdot {\vec{e}}_{j 2} )}{\vert \vec{R} - {\vec{Y}}_{j 2} \vert} ) , & ( 2 )\end{matrix}$$
wherein j denotes a symbol for identifying each of the magnetic sensor pairs, Sⱼ denotes a linear combination output of a magnetic sensor pair j, A denotes the combination coefficient, b₀ denotes a normalized magnetic field generated by a current flowing through the electric wire to be measured, bₙₙ denotes a normalized external magnetic field generated by a neighboring electric wire, b_{c} denotes a constant external magnetic field, eₛⱼ denotes a magnetic sensitivity unit vector of the magnetic sensor pair j, eⱼ₁ denotes a unit vector of the magnetic field of the neighboring electric wire at a position of the inner magnetic sensor element of the magnetic sensor pair j, and eⱼ₂ denotes a unit vector of the magnetic field of the neighboring electric wire at a position of the outer magnetic sensor element of magnetic sensor pair j, and
wherein position vectors of the inner magnetic sensor element and the outer magnetic sensor element of the magnetic sensor pair j in a cross-sectional plane perpendicular to the axis direction of the electric wire to be measured are referred to as Yⱼ₁ (absolute value is Y₁) and Yⱼ₂ (absolute value is Y₂), respectively, a position vector of the neighboring electric wire is referred to as R (absolute value is R), and a positional displacement vector of the electric wire to be measured is referred to as ΔX (absolute value is ΔX).
